(19) United States
(12) Patent Application Publication
(10) Pub. No.: US 2006/0174852 A1
(43) Pub. Date: Aug. 10, 2006

(54) Oscillating-piston machine and oscillating-piston machine arrangement

(76) Inventor: Herbert Huettlin, Loerrach (DE)

Correspondence Address: ST. ONGE STEWARD JOHNSTON & REENS, LLC, 986 BEDFORD STREET, STAMFORD, CT, 06905-5619, US

(21) Appl. No.: 11/258,992

(22) Filed: Oct. 26, 2005

(30) Foreign Application Priority Data
Feb. 8, 2005 (DE) 10 2005 007 912.1

(51) Int. Cl. F02B 53/00; F01C 3/00

(52) U.S. Cl. 123/241; 418/68

(57) ABSTRACT

An oscillating-piston machine includes a housing, which has a spherical housing inner wall, at least one piston, which is arranged in the housing and can pivote about a pivot axis passing through the centre of the housing, the at least one piston executing reciprocating pivoting movements when the shaft is rotating, and an at least first surface, which extends radially with respect to the housing inner wall, on a front side of the at least one piston delimiting at least a first working chamber. A rotor element, which is rotationally fixedly connected to the shaft and is arranged outside the centre of the housing, is arranged on a rear side of the at least one piston, the rear side of the at least one piston defining at least one circular running surface, which is not radially oriented, along which the rotor element runs when the shaft is rotating and which forms an angle of ≠90° with the axis of rotation, while the at least one piston does not rotate about the axis of rotation.

### CROSS REFERENCE TO RELATED APPLICATION

The present application claims priority of German patent application No. 10 2005 007 912.1 filed on Mar. 8, 2005.

### BACKGROUND OF THE INVENTION

The invention generally relates to oscillating-piston machines.

The invention also relates to an oscillating-piston machine arrangement, which includes a plurality of oscillating-piston machines.

Oscillating-piston machines, and in particular an oscillating-piston machine in accordance with the present invention, can be used as internal combustion engines, as pumps or as compressors. An oscillating-piston machine according to the present invention is preferably used as an internal combustion engine and is described in this form in the present description.

If an oscillating-piston machine is used as an internal combustion engine, the individual strokes of intake, compression, ignition of the combustion mix and expansion and exhaust of the burnt combustion mix are produced by reciprocating pivoting movements of the individual pistons between two limit positions.

Among the known oscillating-piston machines are those with a spherical geometry of the housing.

In the case of an oscillating-piston machine known from document WO 03/067033 A1, in the name of the present Applicant, a plurality of pistons are arranged in the spherical housing; these pistons jointly revolve about an axis of revolution which is substantially fixed in the centre of the housing, and as they revolve they execute reciprocating pivoting movements in the housing about a respective pivot axis, with in each case two adjacent pistons pivoting in opposite directions. In this known oscillating-piston machine, in each case two pistons located diametrically opposite with respect to the centre of the housing are connected to one another to form a double piston, and two piston pairs of this type are arranged such that they cross over one another in the centre of the housing. A working chamber is formed between in each case two opposite pistons of the piston pairs, so that the known oscillating-piston machine has two working chambers. The size of the two working chambers, which are arranged diametrically opposite with respect to the centre of the housing, increases and decreases in the same direction during the reciprocating pivoting movement of the pistons. The pivoting movement of the piston of this known oscillating-piston machine is imparted from the revolving movement of the pistons about the axis of rotation by guide members which are arranged at the pistons and are guided in one or more grooves in the housing; the grooves are designed as control cams.

Document DE 25 19 911 A1 has disclosed an oscillating-piston machine, the working principle of which differs from the known oscillating-piston machine described above.

In an exemplary embodiment which is illustrated in FIG. 5 of that document and which is used as the starting point for the present invention, the known oscillating-piston machine has a substantially spherical piston, out of which a segment in the form of a wedge of a sphere has been cut. The spherical piston is surrounded by a likewise spherical rotor, the piston being rotationally fixedly connected to the surrounding rotor by a partition which passes through the working chamber, which is formed by the cut out in the form of a wedge of a sphere. On account of the piston and the surrounding rotor being coupled in a rotationally fixed manner, they both revolve about the axis of rotation, with the spherical piston having a second axis of rotation, which is positioned obliquely with respect to the axis of rotation, so that the oblique position of the axis of rotation of the piston with respect to the axis of rotation of the shaft produces a pivoting movement of the piston about a pivot axis running perpendicular to the axis of rotation.

One drawback of this design is the way in which the pivoting movements of the spherical piston are driven; this is by means of two obliquely disposed axes of rotation. Such an arrangement requires a highly accurate orientation of the axes of rotation, such that they intersect one another precisely in the centre of the housing, otherwise the machine cannot be guaranteed to work. Furthermore, the one working chamber, which is formed by the cut out in the form of a wedge of a sphere in the spherical piston, is of relatively small and shallow volume. The maximum opening angle of the working chamber in this design is less than 45°.

In a further embodiment illustrated in FIGS. 1 and 4 of that document, two pistons, which are in the form of a ring section, are arranged in the spherical housing. The two pistons are connected to a swash plate, which is arranged in the centre of the housing and is fixedly connected to the shaft that can rotate about the axis of rotation, via a rod. The swash plate is arranged obliquely with respect to the axis of rotation. When the shaft rotates, the obliquely disposed swash plate effects a reciprocating pivoting movement of the two pistons. This oscillating-piston machine has the drawback that the drive, in the centre of the housing, of the pistons, by means of the swash plate takes up a large amount of space in the housing, which is at the expense of large working chambers. The advantage which is inherently produced by the spherical symmetry of the housing, namely that a large volume of space is provided for a small surface area, is consequently lost again. The working chambers defined by the two pistons are formed at end sides of the two pistons and are likewise in the form of a ring segment. Both the displacement of the pistons and the volume of the working chambers are relatively small. The degree of compression which can be achieved is relatively low if an oscillating-piston machine of this type is used as an internal combustion engine.

### SUMMARY OF THE INVENTION

The invention is based on the object of improving an oscillating-piston machine of the type described in the introduction such that the abovementioned drawbacks are avoided and in particular that a simple structure comprising geometrically simple elements is achieved combined, at the same time, with better utilization of space for the at least one working chamber.

According to an aspect of the invention, an oscillating-piston machine is provided, comprising a housing having a spherical housing inner wall and a centre, at least one piston arranged in the housing and being able to pivote about a pivot axis passing through the centre of the housing, the at least one piston being operatively connected to a shaft being able to rotate about an axis of rotation likewise passing through the centre of the housing, in such a manner that the at least one piston executes reciprocating pivoting movements when the shaft is rotating, at least a first surface extending radially with respect to the housing inner wall and delimiting, on a front side of the at least one piston, at least a first working chamber, a rotor element rotationally fixedly connected to the shaft and arranged outside the centre of the housing, being arranged on a rear side of the at least one piston, the rear side of the at least one piston defining at least one circular running surface which is not radially oriented with respect to the spherical housing inner wall, along which the rotor element runs when the shaft is rotating and which forms an angle of ≠90° with the axis of rotation, while the at least one piston does not rotate about the axis of rotation.

By virtue of the rotor element running on the rear side of the piston outside the centre of the housing, the oscillating-piston machine according to the invention allows better utilization of space in the housing for the at least one working chamber and a significantly greater pivoting stroke on the part of the at least one piston than in the known oscillating-piston machine, in which the rotor element is formed in the centre of the housing and in a radial orientation. At the same time, if the oscillating-piston machine according to the invention is used as an internal combustion engine, this makes it possible to achieve a significantly higher compression ratio for the combustion mix. The oscillating-piston machine according to the invention also, unlike the known oscillating-piston machine, has parts which are of a geometrically simple shape, and prevent the at least one piston from revolving about the axis of rotation with the shaft in the housing. This reduces the wear to the at least one piston and the seals, which may be arranged at the piston in order to seal off the working chamber. The at least one rotor element of the oscillating-piston machine according to the invention runs on the rear side of the at least one piston, i.e. the opposite side from the front side delimiting the working chamber, and as it does so brings about the reciprocating pivoting movement of the at least one piston.

In a preferred configuration, the rotor element likewise has at least one circular running surface, which faces the rear side of the at least one piston and runs along the at least one circular running surface of the at least one piston.

This measure has the advantage that the rotor element bears against the rear side of the piston at least over the area of an entire ring, with the result that a uniform distribution of load combined with a high transmission of force is achieved on the rear side of the piston.

In a further preferred configuration, the at least one running surface is present at an edge, located close to the housing inner wall, of the rear side of the at least one piston.

In this case, it is advantageous that the at least one running surface can be at a maximum distance from the axis of rotation, with the result that the pivoting movement of the at least one piston takes place with the highest possible torque exerted by the rotor element, with the result that, for example, a combustion mix which has already been admitted to the working chamber at a super atmospheric pressure can be compressed with a high force.

In a further preferred configuration, the rotor element bears on the at least one circular running surface of the at least one piston by means of a free-running bearing.

This measure advantageously greatly reduces friction losses between the rotor element and the rear side of the piston.

With a view to achieving an advantageously simple structure, which requires only a small number of parts, of the oscillating-piston machine according to the invention, the rotor element is directly connected to the shaft.

In a further preferred configuration, the rotor element is designed substantially in the form of a spherical cap, the convex side of which faces the housing inner wall, with the cap pole of the spherical cap being arranged eccentrically with respect to the shaft.

With this design, the rotor element fits optimally into the spherical geometry of the housing of the oscillating-piston machine and can be of particularly stable design with a view to a high transmission of force to the piston. On the side facing the housing inner wall and/or the piston, the spherical cap may also have one or more depressions, which can be used in particular as a lubricating and cooling space between the rotor element and the housing inner wall or the piston.

In a further preferred configuration, the rotor element bears against the housing inner wall on the centrifugal force side by means of a free-running bearing, in particular a ball bearing.

On account of the fact that the rotor element is arranged eccentrically with respect to the axis of rotation, centrifugal forces arise during rotation about the axis of rotation, and these centrifugal forces can be absorbed by the free-running bearing, advantageously with little friction against the housing inner wall.

In a further preferred configuration, the at least one piston, on its front side, has a further surface which extends radially with respect to the housing inner wall and includes an angle of less than 180° with the first surface, the further surface delimiting a second working chamber, which is separated from the first working chamber.

In this context, it is advantageous that one piston forms two working chambers in the housing of the oscillating-piston machine, and the size of these working chambers is reduced or increased in opposite directions during the reciprocating pivoting movement of the at least one piston. In this way, if the oscillating-piston machine is used as an internal combustion engine, it is possible to create a two-cylinder engine using just one piston, in which case the reciprocating pivoting movement of the at least one piston requires just one rotor element of the configuration described above to reduce or increase the size of the two working chambers.

In a further preferred configuration, the at least one piston is approximately in the shape of a triangle when seen in section transversely with respect to the pivot axis.

A piston geometry of this type is advantageously simple, so that the at least one piston can be produced in a simple way from a solid material by a material-removing process.

By way of example, the first and second surfaces delimiting the two working chambers, of the at least one piston include an angle of approximately 120° to approximately 150°, preferably an angle of approximately 135°.

In a further preferred configuration, the pivot axis of the at least one piston is formed by a journal, on which the at least one piston is mounted, the journal being arranged moveably in the housing, so that when the shaft is rotating it can execute a reciprocating pivoting movement in a plane defined by the pivot axis and the axis of rotation.

Mounting the at least one piston on a journal leads to low-friction mounting of the piston about the pivot axis. The oblique positioning of the rotor element with respect to the axis of rotation at the at least one piston causes the at least one piston, in addition to the pivoting movement about the pivot axis, to execute a pivoting movement in a plane defined by the pivot axis and the axis of rotation. The moveable arrangement of the journal allows this additional pivoting movement of the at least one piston.

It is particularly preferred if a second piston, which can pivot about the same pivot axis as the first piston, is arranged in the housing, the pivoting movements of the first and second pistons being oppositely directed.

The advantage of this measure is that the respective pivoting stroke of the first and second pistons are added cumulatively to form a total stroke, which is double the stroke when only one piston that is capable of pivoting is provided. This advantageously on the one hand creates a larger maximum volume of at least one of the working chambers, since the strokes of the two pistons are added cumulatively to form one total stroke, and also allows a higher compression ratio to be achieved, it being possible to reach a compression ratio of 20:1. As a result, the oscillating-piston machine according to the invention is suitable in particular as a diesel engine.

Accordingly, in a further preferred configuration it is provided that the second piston, together with the first piston, delimits the first chamber and if appropriate the second working chamber.

In a further preferred configuration, the second piston is arranged mirror-symmetrically to the first piston in the housing, with respect to a plane which is transverse with respect to the axis of rotation and parallel to the pivot axis.

This measure makes an advantageous contribution to evening out the masses of the pistons of the oscillating-piston machine. On account of the symmetrical configuration of the pistons, the pivoting movements of the pistons do not lead to an imbalance.

In a further preferred configuration, the second piston is assigned a second rotor element, the second rotor element being rotationally fixedly connected to a second shaft, which rotates about the same axis of rotation as the first shaft but in the opposite direction to the latter.

Although it would be conceivable for the reciprocating pivoting movement of the second piston to be determined directly from the pivoting movement of the first piston, for example as a result of the two pistons bearing in rolling contact against one another, the provision of a further rotor element for the second piston has the advantage that the moving parts of the oscillating-piston machine according to the invention overall can be of symmetrical and therefore balanced-mass design, and that a dedicated drive is present for the second piston, so that the second piston is likewise actively controlled.

In this context, it is furthermore preferred if the second shaft is led through the first shaft, with the first shaft and the second shaft at the end side being connected to a third shaft by way of a transmission arrangement, preferably a bevel gear mechanism.

This configuration achieves, by measures of simple design, the advantage whereby the rotational energies of the two shafts rotating in opposite directions are converted into common rotation of a third shaft, which then forms the drive or output shaft of the oscillating-piston machine.

To enable the journal, provided in accordance with one of the preceding configurations, to pivote in the plane defined by the pivot axis and the axis of rotation by structurally simple measures, in a further preferred configuration it is provided that at the centre of the housing the second shaft has a ball which is mounted in a spherical receiving part in the journal. The journal can therefore pivote about the ball.

The only mass imbalance which is produced by the eccentric rotor element is eliminated, in a preferred and advantageously simple measure, by the fact that a mass compensation element is arranged on the first shaft and if appropriate on the second shaft in order to compensate for the asymmetric mass distribution of the first and if appropriate second rotor elements with respect to the axis of rotation.

The mass compensation element is preferably adjustable in order to balance the oscillating-piston machine.

Furthermore, the invention relates to an oscillating-piston machine arrangement, having a first oscillating-piston machine in accordance with one or more of the configurations listed above, and having at least a second oscillating-piston machine in accordance with one or more of the configurations described above, with the second oscillating-piston machine connected in series to the first oscillating-piston machine.

In this context, it is advantageous that a four-cylinder engine, a six-cylinder engine or even an engine with a greater number of cylinders can be realized if the oscillating-piston machine according to the invention is used as an internal combustion engine. Furthermore, even with two oscillating-piston machines according to the invention connected in series, it is possible to ensure that four successive working strokes follow one another in series without any gaps or interruptions between them.

In this context, it is preferable if the first oscillating-piston machine and the second oscillating-piston machine have a phase location of the piston working positions offset relative to one another by a predetermined angle, preferably of 180°.

This ensures that a working event (expansion) takes place in each position of the pistons, so that the oscillating-piston machine arrangement according to the invention runs automatically.

The at least two oscillating-piston machines are preferably connected by means of a transmission arrangement, preferably a bevel gear mechanism, in order for the work performed by the at least two oscillating-piston machines to be transmitted to a common shaft. This then advantageously obviates the need for the abovementioned bevel gear mechanism in an individual oscillating-piston machine.

Further advantages and features will emerge from the following description and the appended drawings.

It will be understood that the features listed above and also those which are yet to be explained below can be used not only in the combination given in each instance, but also in other combinations or as stand-alone measures without departing from the scope of the present invention.

### BRIEF DESCRIPTION OF THE DRAWINGS

Exemplary embodiments of the invention are illustrated in the drawing and are described in more detail below with reference to the drawing, in which:

FIG. 1 shows a perspective overall view of an oscillating-piston machine;

FIG. 2 shows the oscillating-piston machine from FIG. 1 in the form of a side view and partially in longitudinal section, in a first operating position;

FIG. 3 shows the oscillating-piston machine in the same form of illustration as in FIG. 2, in a second operating position;

FIG. 4 shows the oscillating-piston machine in a similar form of illustration to that shown in FIG. 2, in a third operating position;

FIG. 5 shows the oscillating-piston machine in the same form of illustration as in FIG. 2, in a fourth operating position;

FIG. 6 shows the oscillating-piston machine from FIG. 1 in plan view, partially in longitudinal section and in a first operating position, corresponding to the operating position shown in FIG. 2;

FIG. 7 shows the oscillating-piston machine in the same form of illustration as in FIG. 6, in a second operating position corresponding to the operating position illustrated in FIG. 3;

FIG. 8 shows the oscillating-piston machine in the same form of illustration as in FIG. 6, in a third operating position corresponding to the operating position illustrated in FIG. 4;

FIG. 9 shows the oscillating-piston machine in the same form of illustration as in FIG. 6, in a fourth operating position which corresponds to the operating position illustrated in FIG. 5;

FIG. 10 shows the oscillating-piston machine in the same form of illustration as in FIG. 2, but now also illustrating the pistons in longitudinal section;

FIG. 11 shows a cross-sectional illustration of the oscillating-piston machine in section on line XI-XI in FIG. 10;

FIG. 12 shows a longitudinal-section illustration through the oscillating-piston machine in section on line XII-XII in FIG. 10;

FIG. 13 shows an oscillating-piston machine arrangement comprising two oscillating-piston machines in accordance with FIG. 1-12;

FIG. 14a) to h) show eight illustrations of an oscillating-piston machine in accordance with FIG. 1-12 in eight different operating positions;

FIG. 15a) to h) show the oscillating-piston machine arrangement in FIG. 13 in eight different operating positions.

### DETAILED DESCRIPTION OF PREFERRED EMBODIMENTS

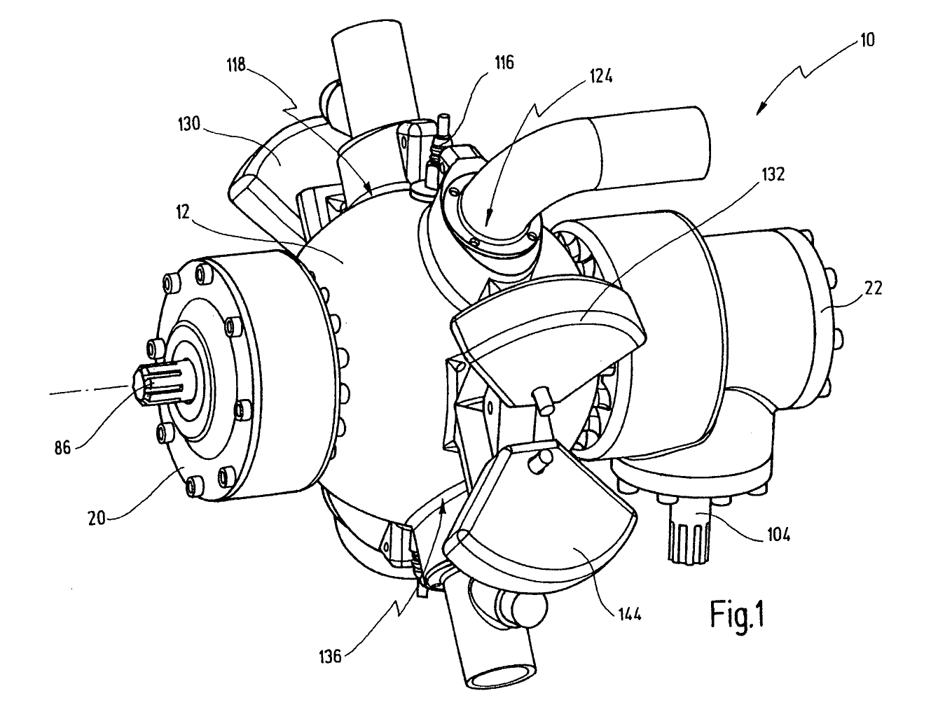

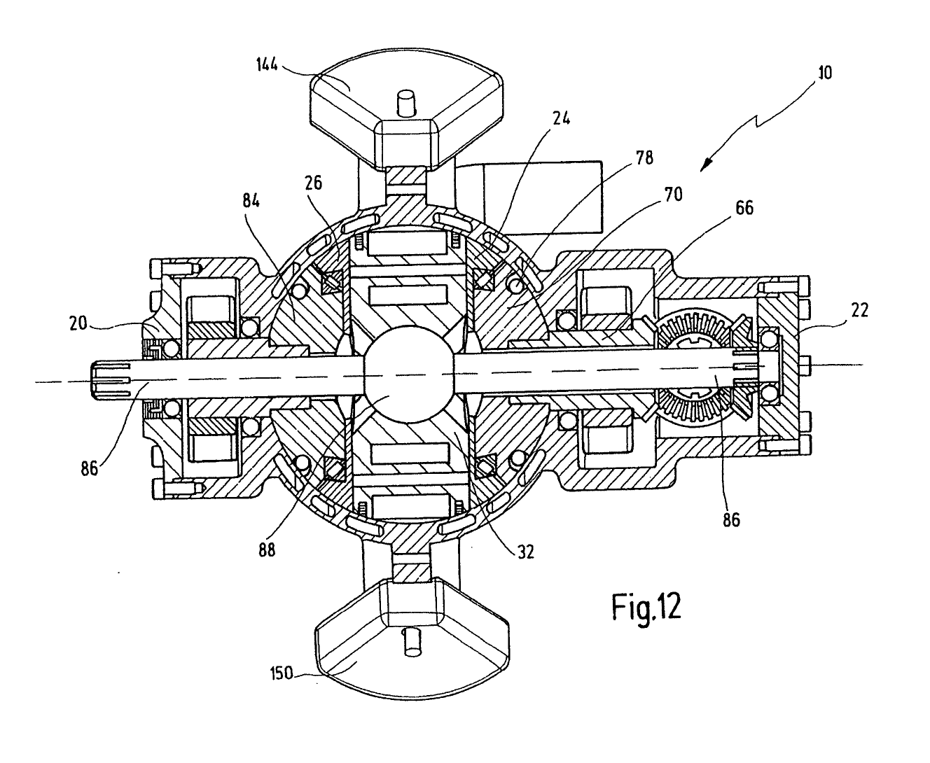

FIGS. 1-12 illustrate an oscillating-piston machine 10, which is denoted by the overall reference numeral 10, in accordance with an exemplary embodiment of the invention. The oscillating-piston machine 10 in accordance with the present exemplary embodiment is realized in the form of an internal combustion engine.

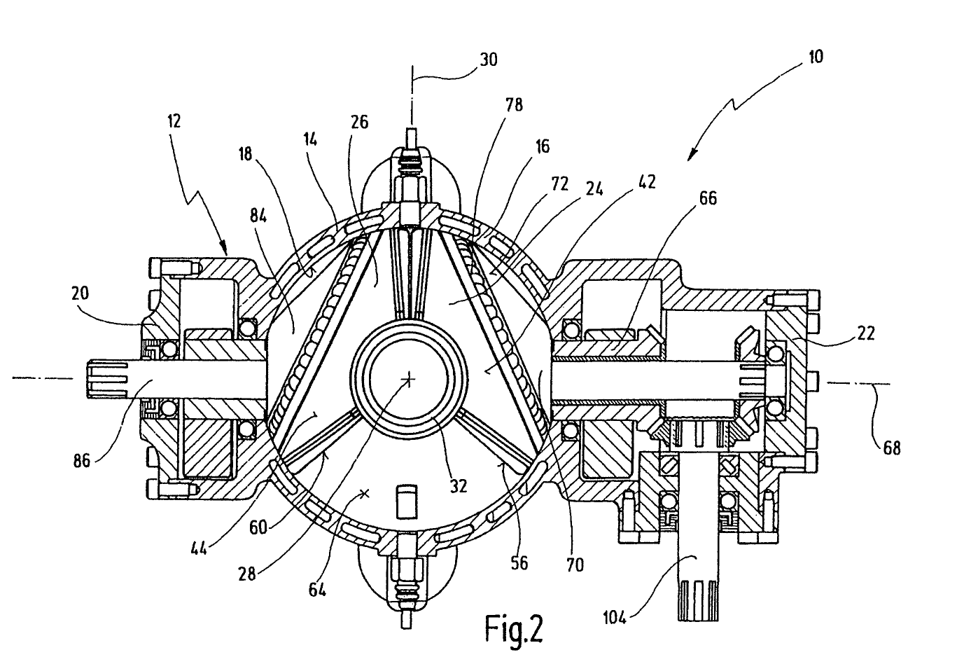

The oscillating-piston machine 10 has a housing 12 which is constructed in the form of a substantially symmetrical sphere. The housing has two housing halves 14 and 16 (FIG. 2) which can be detached from one another.

A housing inner wall 18 of the housing 12 is of spherical design. At the end sides, the housing 12 is closed off by in each case one housing end cover 20 and 22 (FIGS. 1 and 2).

Two pistons 24 and 26 are arranged in the housing 12. The pistons 24 and 26 can pivote about a pivot axis 28, as will be described in more detail below. In FIGS. 2-5, the pivot axis 28 is perpendicular to the plane of the drawing.

The pistons 24 and 26 are designed identically to one another and are arranged mirror-symmetrically in the housing 12 with respect to a plane 30 which includes the pivot axis 28.

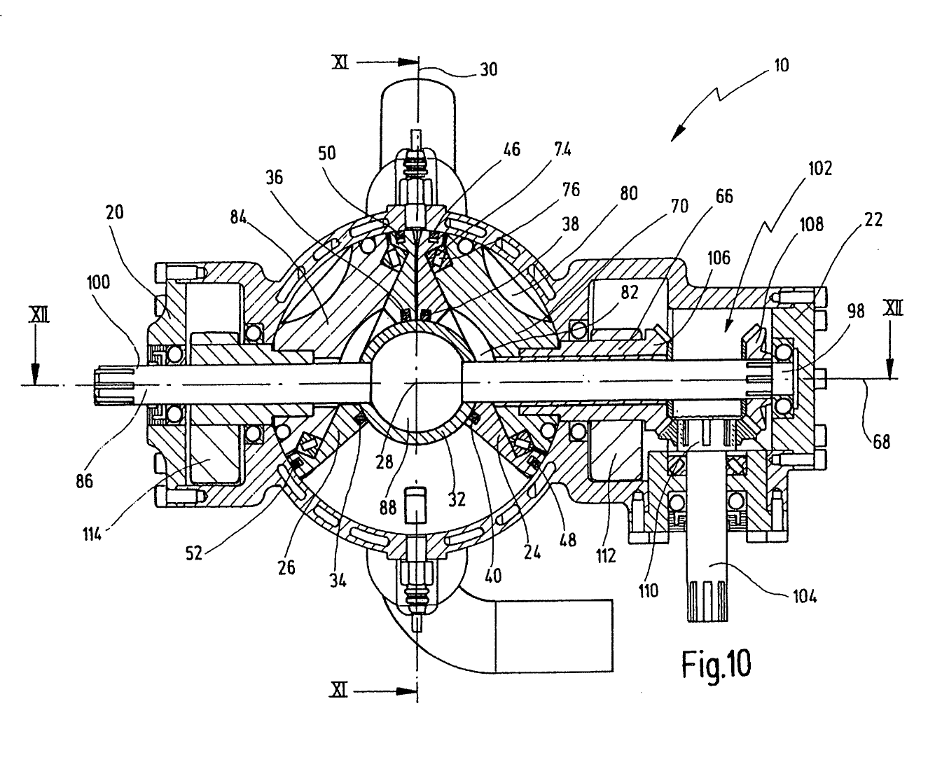

The pivot axis 28 is formed by a journal 32 on which the pistons are mounted such that they can pivote, whereas the journal 32 cannot pivote about the pivot axis 28. The pistons 24 and 26 are sealed off with respect to the journal 32 by means of linear seals 34, 36 (piston 26) and 38, 40 (piston 24), which are arranged in grooves in the pistons 24, 26, as illustrated in FIG. 10. The seals 34-40 can move in the grooves towards the journal 32 in order to be able to bear in a sealing manner against the journal 32.

In accordance with FIGS. 2 and 10, the pistons 24, 26 are in the shape of a triangle when seen in cross section through the pivot axis 28. By contrast, a respective outer surface 42 or 44 of the pistons 24 and 26, facing the housing inner wall 18, is curved convexly in the shape of a spherical surface, matching the spherical shape of the housing inner wall 18.

The pistons 24 and 26 are sealed against the housing inner wall 18 (FIG. 10) by means of seals 46, 48 (piston 24) and 50, 52 (piston 26), which are correspondingly in the form of spherical surface lines. The seals 46-52 are in turn recessed in corresponding grooves in the pistons 24 and 26 and can move radially therein towards the housing inner wall 18, in order to form a seal against the housing inner wall 18.

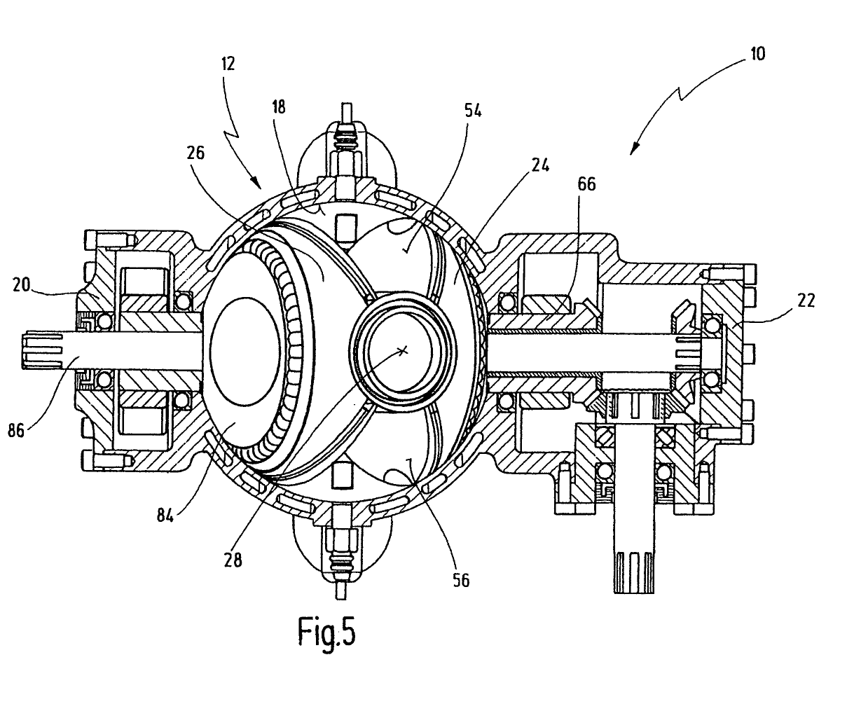

On its front side, the piston 24 has a first surface 54, which extends towards the housing inner wall 18 radially with respect to the pivot axis 28, and, likewise on its front side, a second surface 56, which likewise extends towards the housing inner wall 18 in the radial direction with respect to the pivot axis 28 (FIG. 5).

Surfaces 54 and 56 include an angle of approximately 135° with one another.

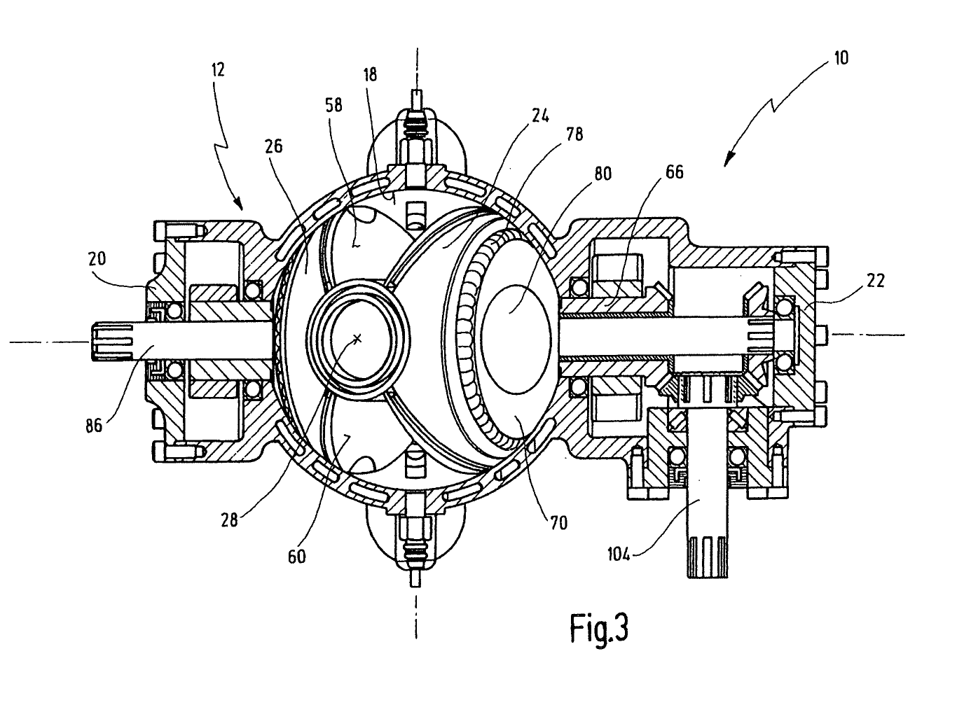

The piston 26 has a first surface 58, which extends to the housing inner wall 18 radially with respect to the pivot axis 28, and a second surface 60, which extends radially to the housing inner wall 18 with respect to the pivot axis 28 (FIG. 3).

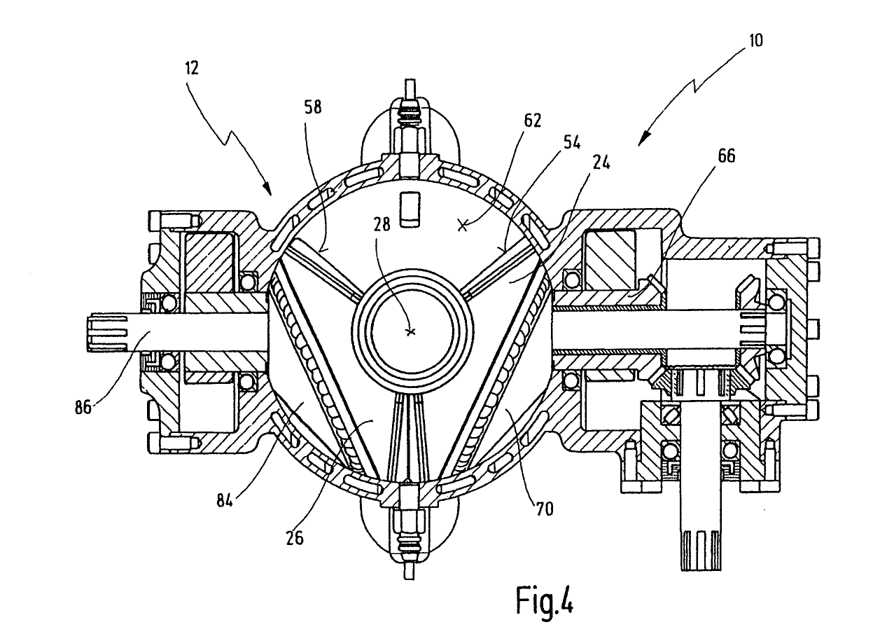

The surface 54 of the piston 24 and the surface 58 of the piston 26, together with the journal 32 and the housing inner wall 18, delimit a first working chamber 62 (FIG. 4). The surface 56 of the piston 24 and the surface 60 of the piston 26, together with the journal 32 and the housing inner wall 18, delimit a second working chamber 64 (FIG. 2). The second working chamber 64 is located diametrically opposite the first working chamber 62 with respect to the pivot axis 28.

During the reciprocating pivoting movement of the pistons 24 and 26 about the pivot axis 28, the size of the working chambers 62, 64 is increased and decreased in opposite directions. FIG. 4 illustrates the working chamber 62 in the position of its maximum volume, whereas the working chamber 64 is illustrated in the position of its minimum volume, and FIG. 2 illustrates the working chamber 64 in a position of its maximum volume, whereas the working chamber 62 is at its minimum volume.

In the positions of maximum volume, the surfaces 54 and 58 or 56 and 60 include an angle of approximately 100 to 120°, in the exemplary embodiment shown approximately 110°, i.e. approximately one third of the angle of a full circle.

The text which follows provides a more detailed description of the structure of the oscillating-piston machine 10 with regard to the control mechanism for bringing about the pivoting movements of the pistons 24 and 26.

For this purpose, the oscillating-piston machine 10 has a first shaft 66, which can turn or rotate about an axis of rotation 68. The axis of rotation 68 intersects the pivot axis 28 in the centre of the housing. In certain operating positions of the pistons 24 and 26 as shown in FIGS. 2 and 4, the axis of rotation 68 is perpendicular to the pivot axis 28, while in other operating positions, such as those shown in FIGS. 3 and 5, the axis of rotation 68 and the pivot axis 28 include an angle of ≠90°.

The shaft 66 is rotationally fixedly connected to a first rotor element 70. The rotor element 70 is substantially in the form of a spherical cap, so that an outer side 72 is matched to the spherical shape of the housing inner wall 18. In the housing 12, the rotor element 70 is arranged outside the centre of the housing, and the rotor element in the form of the spherical cap is rotationally fixedly connected to the shaft outside its spherical cap pole, so that the rotor element 70 is arranged asymmetrically or eccentrically with respect to the axis of rotation 68.

On a rear side of the piston 24, facing away from the abovementioned front side, a circular running surface 74, which is not radially oriented and along which the rotor element 70 runs when the shaft 66 is rotated without the piston 24 revolving about the axis of rotation 68, is defined at the piston 24 in the vicinity of its edge facing the housing inner wall. The running surface 74 always forms an angle of ≠90°, in the exemplary embodiment shown an angle of approximately 110°, with the axis of rotation 68. The rotor element 70 therefore bears on the rear side of the piston 24 by means of an oblique bearing which describes a full circle. In this case, the bearing of the rotor element 70 against the running surface 74, which is in the form of a ring of a circle, of the piston 24 is made low in friction by the use of a free-running bearing 76 (FIG. 10). The rotor element 70 bears against the housing inner wall 18 on the centrifugal force side by means of a free-running bearing in the form of a ball bearing 78, with the balls of the ball bearing 78 being arranged on a circle line.

On the outer side, facing the housing inner wall 18, the rotor element 70 has a depression 80 as coolant and lubricant space.

The rotor element 70 has a further depression 82 on its side facing the piston 24, which likewise serves to improve the lubrication.

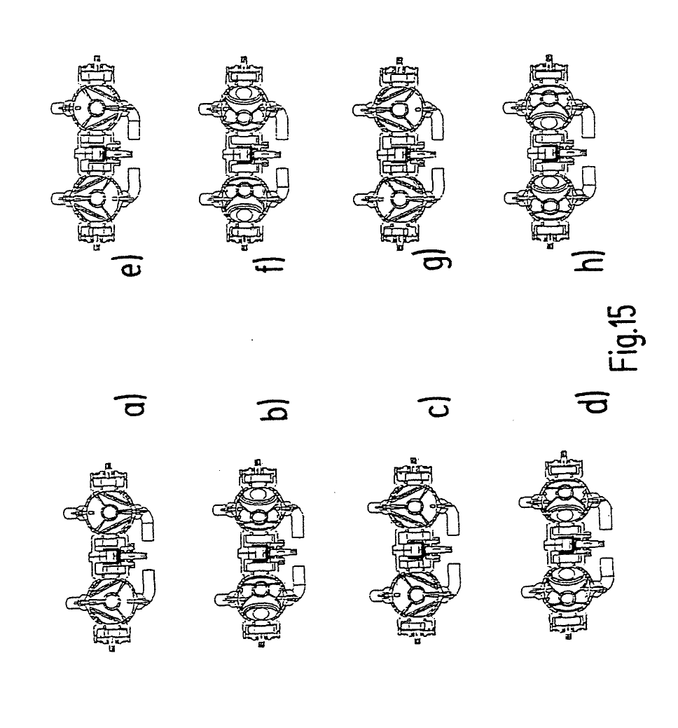

The piston 26 is assigned a rotor element 84 which is identical to the rotor element 70 and, in the operating position shown in FIG. 10 or the operating positions shown in FIGS. 2 and 4, is arranged mirror-symmetrically to the rotor element 70 in the housing 12 with respect to the plane 30, whereas in other operating positions as shown in FIGS. 3 and 15 it is point-symmetrical with respect to the centre of the housing. The rotor element 84 can rotate about the same axis of rotation 68, but rotates in the opposite direction to the rotor element 70. On account of the rotor element 84 being designed identically to the rotor element 70, the details which have been described above in connection with the rotor element 70 and also relate to the interaction of the rotor element 84 and the piston 26 are not described in further detail.

The rotor element 84 is rotationally fixedly connected asymmetrically or eccentrically to a shaft 86, which can likewise rotate about the axis of rotation 68 and which, as has already been mentioned, rotates in the opposite direction to the shaft 66.

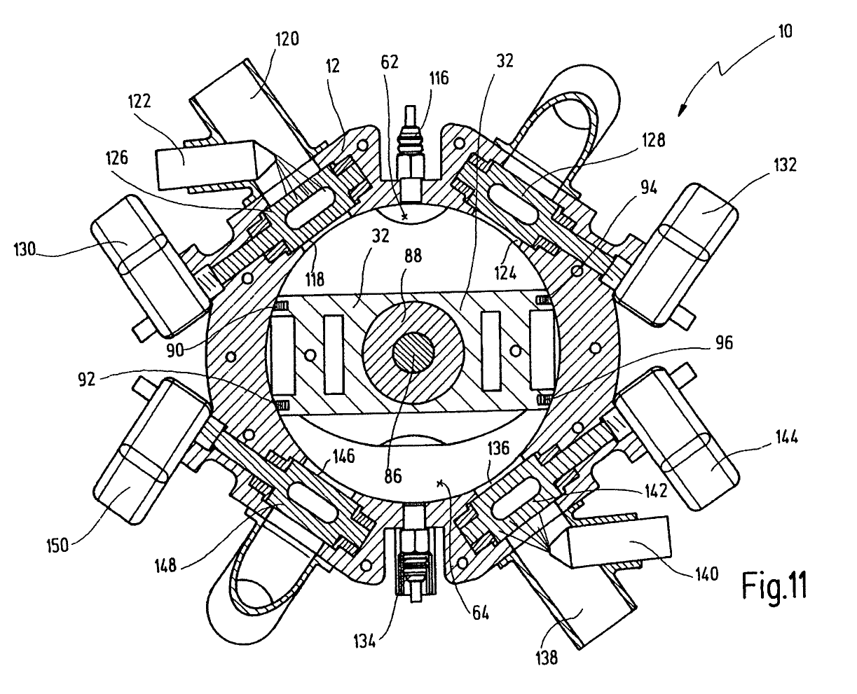

The shaft 86 is passed through the centre of the housing (FIG. 11), and in the region of the centre of the housing has a ball 88 which is arranged in the journal 32. The ball 88 may be fixedly connected to the shaft 86 or may be arranged as a separate part thereon. Therefore, the journal 32 can execute a pivoting movement about the ball 88, specifically in the plane defined by the axis of rotation 68 and the pivot axis 28. FIG. 11 also illustrates how the journal is sealed against the housing inner wall at the end sides by means of seals 90, 92 and 94 and 96. Furthermore, the shaft 86 is passed through the shaft 66 and at one end 98 is mounted rotatably in the housing end cover 22. The other end 100 of the shaft 86 is mounted rotatably in the housing end cover 20.

The shaft 66 and the shaft 86 are connected to one another by means of a transmission arrangement 102, in order to convert the oppositely directed rotations of the shaft 86 and the shaft 66 into a rotation of a further shaft 104. The transmission arrangement 102 is designed in the form of a bevel gear mechanism, in which a first bevel gear is rotationally fixedly connected to the shaft 66, a second bevel gear 108 is rotationally fixedly connected to the shaft 86 and a spur gear 110 is rotationally fixedly connected to the shaft 104.

To compensate for the asymmetric mass distribution of the rotor element 70 and the rotor element 84 with respect to the axis of rotation 68, a mass compensation weight 112 is arranged on the shaft 66 and a mass compensation weight 114 is arranged on the shaft 86, each of these weights being rotationally fixedly connected to the shaft 66 or 86, so that they rotate about the axis of rotation 68 when the shafts 66, 86 rotate. The mass compensation weights 112 and 114 are adjustable for balancing purposes.

In accordance with the oscillating-piston machine 10 being used as an internal combustion engine, the oscillating-piston machine 10 also comprises the following elements, which are described with reference to FIG. 11.

The working chamber 62 is assigned a spark plug 116, which is arranged on the housing 12. Furthermore, the working chamber 62 is assigned an inlet opening 118 for admitting a fuel-air mix through the housing 12. An air intake pipe 120, in which an injection nozzle 122 for injecting a fuel opens out, is connected to the inlet opening 118.

Furthermore, the working chamber 62 is assigned an outlet opening 124 in the housing 12, through which the burnt and previously expanded combustion mix is discharged.

In both the inlet opening 118 and the outlet opening 124 there is a valve 126 and 128 respectively, to open or close the inlet opening 118 and the outlet opening 124. The valves 126,128 are designed as rotary valves with electrical or electronically controlled 90° drives 130 and 132, respectively. FIG. 11 illustrates the valves 126 and 128 in their closed position, and they are moved into their open position as a result of the valves 126 and 128 being rotated through 90°. It will be understood that when the oscillating-piston machine 10 is operating, the valves 126 and 128 can only be opened alternately rather than simultaneously, but may be closed simultaneously.

In a corresponding way, the working chamber 64 is assigned a spark plug 134, an inlet opening 136 with air intake pipe 138 and injection nozzle 140, a valve 142 with drive 144 and an outlet opening 146 with valve 148 and drive 150.

It will be understood that conventional spring-loaded tulip valves which are controlled via a cam shaft, or alternatively axially opening solenoid valves, may also be used instead of rotary valves.

The following text describes the kinematics of the oscillating-piston machine 10 with reference to FIGS. 2-5 and 6-9.

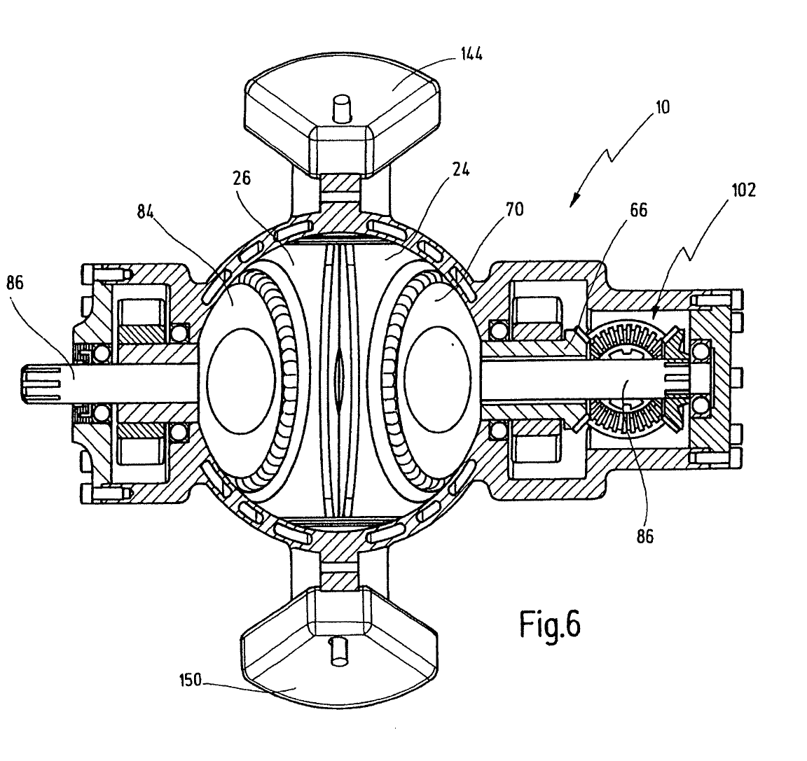

In FIGS. 2 and 6, the volume of the (upper) working chamber 62 is at a minimum and the volume of the (lower) working chamber 64 is at a maximum.

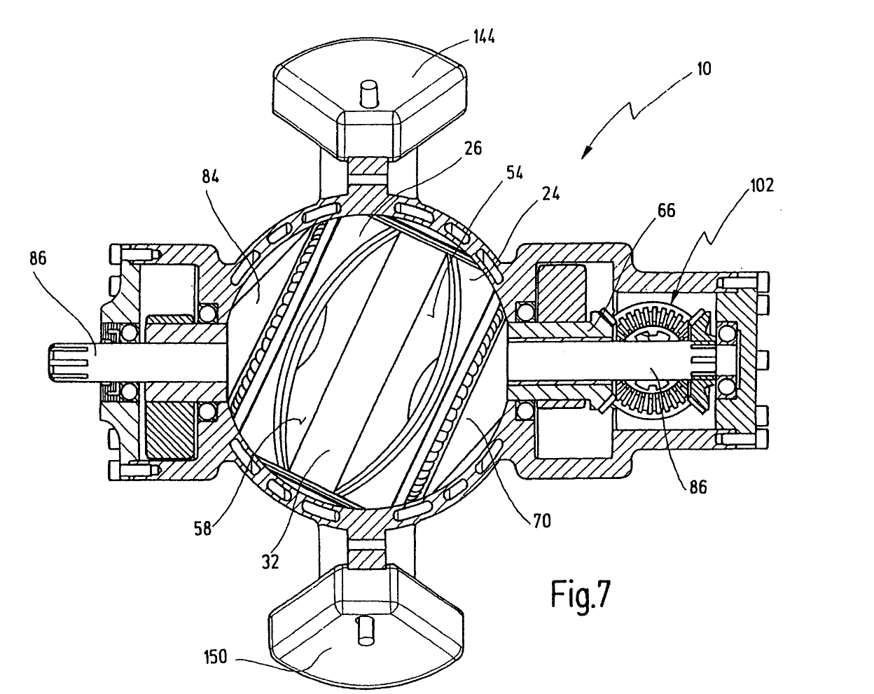

Starting from FIG. 2, in FIG. 3 the shaft 66 has rotated 90° in the anticlockwise direction about the axis of rotation 68, whereas the shaft 86 has rotated 90° in the opposite direction, i.e. in the clockwise direction, about the axis of rotation 68. In the process, the volume of the working chamber 62 has increased and the volume of the working chamber 64 has decreased compared with FIG. 2, on account of the fact that the pistons 24 and 26 have executed a pivoting movement about the pivot axis 28, caused by corresponding rotations of the rotor elements 70 and 84 on the rear sides of the pistons 24 and 26. In the meantime, the pivot axis 28 or the journal 32 has likewise been displaced, i.e. executed a pivoting movement in the clockwise direction in FIG. 3 or FIG. 7 in the plane defined by the pivot axis 28 and by the axis of rotation 68.

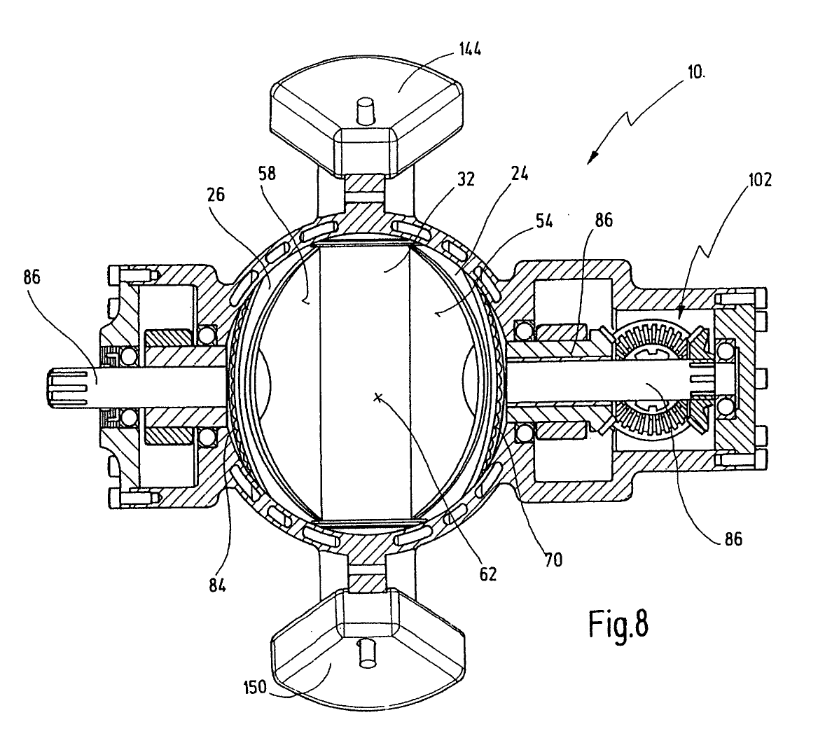

Following a further rotation of the shafts 66 and 86 through 90° in accordance with FIGS. 4 and 8, the pistons 24 and 26 have pivoted into their opposite pivoting position from FIGS. 2 and 5, in which the volume of the working chamber 62 is at a maximum and the volume of the working chamber 64 is at a minimum. The pivot axis 28 or journal 32 has once again pivoted back into the starting position shown in FIGS. 2 and 5.

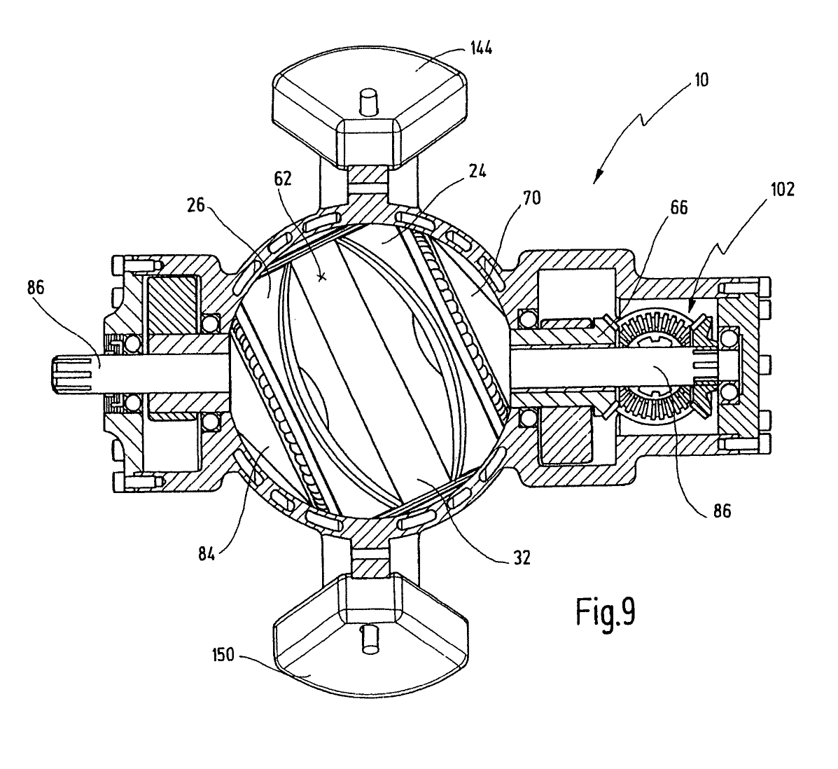

In the event of a further rotation of the shafts 66 and 86 through a further 90° about the axis of rotation 68, as shown in FIGS. 5 and 9, the pistons 24 and 26 pivoted back towards their starting position, so that the size of the working chamber 62 is reduced again and that of the working chamber 64 has increased again. The pivot axis 28 has now pivoted counterclockwise about the centre of the housing.

Further rotation of the shafts 66 and 86 through 90° once again leads to the starting position shown in FIGS. 2 and 6.

The oppositely directed rotation of the shafts 66 and 86 leads to rotation of the shaft 104 with a constant direction of rotation.

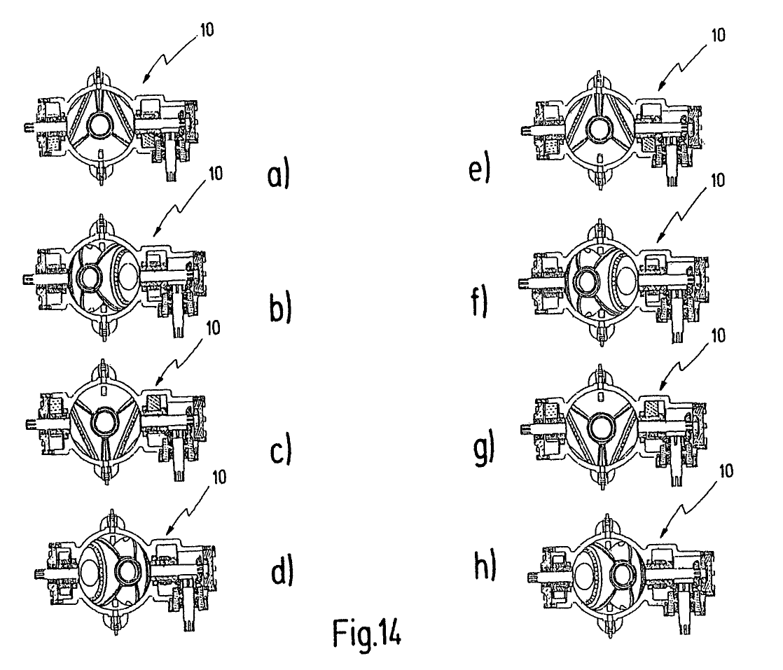

FIGS. 14a)-h) illustrate eight successive working strokes in the working chambers 62 and 64.

FIG. 14a) illustrates the oscillating-piston machine 10 at an instant at which the compression operation has just finished in the working chamber 62 and the expansion operation (after ignition) is just beginning.

By contrast, in working chamber 64 the induction stroke has just ended and the compression operation is just beginning.

All the valves 126, 128, 142, 148 are closed.

FIG. 14b) illustrates the oscillating-piston machine 10 at an instant at which 50% of the expansion operation has taken place in the working chamber 62 and 50% of the compression operation has taken place in working chamber 64. The valves are still closed.

FIG. 14c) illustrates the oscillating-piston machine 10 at an instant at which the expansion operation has been completed and the exhaust operation is beginning in the working chamber 62, whereas the compression operation has been completed and the expansion operation (ignition) is just beginning in the working chamber 64.

Whereas in the working sequences shown in FIGS. 14a) and b) all the valves 126, 128, 142, 148 are closed, the (exhaust) valve 128 is now open, whereas the remaining valves 126, 142 and 148 are still closed.

In the next working stroke shown in FIG. 14d), exhaust operation is 50% complete in the working chamber 62 and the expansion operation is 50% complete in the working chamber 64. The valve 128 remains open, while all the other valves are still closed.

In FIG. 14e), the exhaust operation is now 100% complete in the working chamber 62, and the valve 128 has accordingly been closed again. The intake operation then begins again in working chamber 62. The expansion operation is now 100% complete in working chamber 64 and the exhaust operation begins. The (inlet) valve 126 (working chamber 62) is now open, as is the (exhaust) valve 148 (working chamber 64). The other two valves are closed.

FIG. 14f) shows the oscillating-piston machine 10 at an instant at which the intake operation is 50% complete in working chamber 62 (valve 126 still open) and the exhaust operation is 50% complete in working chamber 64 (valve 148 still open).

Now, in accordance with FIG. 14g), the intake operation has completely finished in working chamber 62 (valve 126 is closed again) and the exhaust operation is complete in working chamber 64 (valve 148 is closed again), while the intake operation is beginning in working chamber 64 (valve 142 is opened).

In FIG. 14h), the compression operation is 50% complete in working chamber 62 and the intake operation is 50% complete in working chamber 64 (valve 142 still open).

This then results in the state illustrated in FIG. 14a).

Overall, over the course of FIGS. 14a)-14h) and then back to FIG. 14a), the shafts 66 and 86 have executed a rotation of in each case 720°.

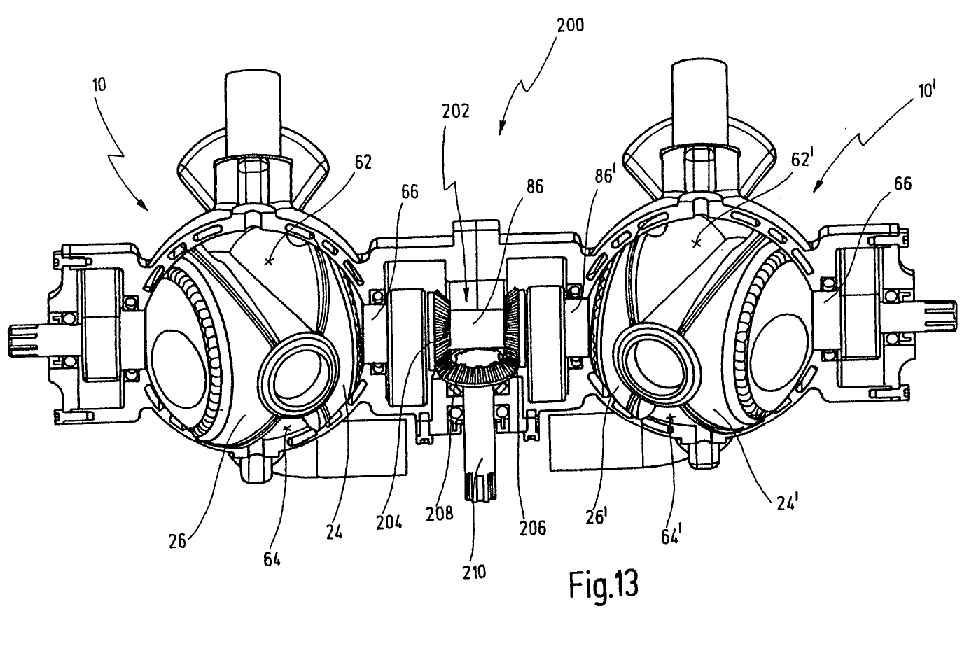

FIG. 13 illustrates an oscillating-piston machine arrangement 200, which is formed from two oscillating-piston machines 10 and 10′ connected in series, the oscillating-piston machine 10′ being of identical design to the oscillating-piston machine 10 shown in FIGS. 1-12.

However, the two oscillating-piston machines 10 and 10′ are not in phase with regard to the phase location of the pistons 24 and 26 and 24′ and 26′, respectively, but rather the phase location of the pistons 24′, 26′ is offset by 180° with respect to the phase location of the pistons 24, 26. The oscillating-piston machines 10 and 10′ are coupled to one another by means of a transmission arrangement 202, which is designed as a bevel gear mechanism. The shaft 66 of the oscillating-piston machine 10 is rotationally fixedly connected to a bevel gear 204, and the shaft 86 is rotationally fixedly connected to a bevel gear 206. The shaft 86′ which rotates in the same direction as the shaft 86, is likewise rotationally fixedly connected to the bevel gear 206. A spur gear 208, which is rotationally fixedly connected to a common drive or output shaft 210 of the oscillating-piston machine arrangement 200, meshes with the bevel gears 204 and 206.

As a result of two oscillating-piston machines 10 and 10′ being arranged in series, with a corresponding phase shift of the piston positions, it is ensured that a working cycle, i.e. expansion of the ignited fuel-air mix, is always taking place in at least one of the oscillating-piston machines 10 and 10′.

FIGS. 15a)-h) illustrate working positions of the oscillating-piston machines 10 and 10′ which correspond to those shown in FIGS. 14a)-h).

In accordance with FIG. 15a), the compression operation is complete in the working chamber 62 of the oscillating-piston machine 10, ignition is taking place and the expansion operation is beginning. In the working chamber 64 of the oscillating-piston machine 10, the intake operation is complete and the compression operation is beginning.

By contrast, in working chamber 62′ of the oscillating-piston machine 10′, the exhaust operation is complete and the intake operation is beginning.

In working chamber 64′of the oscillating-piston machine 10′, the expansion operation is complete and the exhaust operation is beginning.

Starting from FIG. 15a), the further working strokes illustrated in FIGS. 15b)-15h) take place analogously to the diagram of the working strokes presented in FIG. 14 (cf. Table 1 in the annex). The valve positions are also analogous to those given in the description in connection with FIGS. 14a)-14h).

It will be understood that it is not just two oscillating-piston machines which can be coupled to form an oscillating-piston machine arrangement, but rather it is also possible for three or even more oscillating-piston machines to be coupled to one another in a corresponding way.

TABLE 1

| | Oscillating-piston machine 10 | | Oscillating-piston machine 10′ | |
|---|---|---|---|---|
| | Working | Working | Working | Working |
| | chamber 62 | chamber 64 | chamber 62′ | chamber 64′ |
| FIG. | Compression | Intake 100% | Exhaust 100% | Expansion |
| 15a) | 100% | (Start of | (Start of intake) | 100% |
| | (Start of | compression) | | (Start of |
| | expansion) | | | exhaust) |
| FIG. | Expansion 50% | Compression | Intake 50% | Exhaust 50% |
| 15b) | | 50% | | |
| FIG. | Expansion | Compression | Intake 100% | Exhaust 100% |
| 15c) | 100% | 100% | (Start of | (Start of intake) |
| | (Start of | (Start of | compression) | |
| | exhaust) | expansion) | | |
| FIG. | Exhaust 50% | Expansion 50% | Compression | Intake 50% |
| 15d) | | | 50% | |
| FIG. | Exhaust 100% | Expansion | Compression | Intake 100% |
| 15e) | (Start of intake) | 100% | 100% | (Start of |
| | | (Start of | (Start of | compression) |
| | | exhaust) | expansion) | |
| FIG. | Intake 50% | Exhaust 50% | Expansion 50% | Compression |
| 15f) | | | | 50% |
| FIG. | Intake 100% | Exhaust 100% | Expansion | Compression |
| 15g) | (Start of | (Start of intake) | 100% | 100% |
| | compression) | | (Start of | (Start of |
| | | | exhaust) | expansion) |
| FIG. | Compression | Intake 50% | Exhaust 50% | Expansion 50% |
| 15h) | 50% | | | |

What is claimed is:

1. An oscillating-piston machine, comprising:
a housing having a spherical housing inner wall and a centre, at least one piston arranged in said housing and being able to pivote about a pivot axis passing through said centre of said housing,
said at least one piston being operatively connected to a shaft being able to rotate about an axis of rotation likewise passing through said centre of said housing, in such a manner that said at least one piston executes reciprocating pivoting movements when said shaft is rotating,
at least a first surface extending radially with respect to said housing inner wall and delimiting, on a front side of said at least one piston, at least a first working chamber,
a rotor element rotationally fixedly connected to said shaft and arranged outside said centre of said housing, being arranged on a rear side of said at least one piston, and
said rear side of said at least one piston defining at least one circular running surface which is not radially oriented with respect to said spherical housing inner wall, along which said rotor element runs when said shaft is rotating and which forms an angle of ≠90° with said axis of rotation, while said at least one piston does not rotate about said axis of rotation.

2. The oscillating-piston machine of claim 1, wherein said rotor element likewise has at least one circular running surface, which faces said rear side of said at least one piston and runs along said at least one circular running surface of said at least one piston.

3. The oscillating-piston machine of claim 1, wherein said at least one running surface of said at least one piston is present at an edge, located close to said housing inner wall, of said rear side of said at least one piston.

4. The oscillating-piston machine of claim 1, wherein said rotor element bears on said at least one circular running surface of said at least one piston by means of a free-running bearing.

5. The oscillating-piston machine of claim 1, wherein said rotor element is directly connected to said shaft.

6. The oscillating-piston machine of claim 1, wherein said rotor element is designed substantially in the form of a spherical cap, a convex side of which faces said housing inner wall, with a cap pole of said spherical cap being arranged eccentrically with respect to said shaft.

7. The oscillating-piston machine of claim 1, wherein said rotor element bears against said housing inner wall by means of a free-running bearing.

8. The oscillating-piston machine of claim 1, wherein said at least one piston, on a front side of said at least one piston, has a further surface which extends radially with respect to said housing inner wall and includes an angle of less than 180° with said first surface, said further surface delimiting a second working chamber, which is separated from said first working chamber.

9. The oscillating-piston machine of claim 1, wherein said at least one piston is approximately in the shape of a triangle when seen in section transversely with respect to said pivot axis.

10. The oscillating-piston machine of claim 1, wherein said pivot axis of said at least one piston is formed by a journal, on which said at least one piston is mounted, said journal being arranged moveably in said housing so that when said shaft is rotating, said journal is able to execute a reciprocating pivoting movement in a plane defined by said pivot axis and said axis of rotation.

11. The oscillating-piston machine of claim 1, wherein a second piston, which is able to pivote about said same pivot axis as said first piston, is arranged in said housing, said pivoting movements of said first and second pistons being oppositely directed.

12. The oscillating-piston machine of claim 11, wherein said second piston, together with said first piston, delimits at least one of said first working chamber and a second working chamber.

13. The oscillating-piston machine of claim 11, wherein said second piston is arranged mirror-symmetrically to said first piston in said housing, with respect to a plane which is transverse with respect to said axis of rotation and parallel to said pivot axis.

14. The oscillating-piston machine of claim 11, wherein said second piston is assigned a second rotor element, said second rotor element being rotationally fixedly connected to a second shaft, which rotates about said axis of rotation as said first shaft but in opposite direction to said first shaft.

15. The oscillating-piston machine of claim 14, wherein said second shaft is led through said first shaft, with said first shaft and said second shaft being connected to a third shaft by way of a gear transmission arrangement.

16. The oscillating-piston machine of claim 1, wherein a mass compensation element is arranged on said first shaft in order to compensate for an asymmetric mass distribution of said first rotor element with respect to said axis of rotation.

17. An oscillating-piston machine arrangement, comprising:
a first oscillating-piston machine and at least a second oscillating-piston machine which is connected in series to said first oscillating-piston machine, said first oscillating-piston machine and said at least second oscillating-piston machine each comprising:
a housing having a spherical housing inner wall and a centre,
at least one piston arranged in said housing and being able to pivote about a pivot axis passing through said centre of said housing,
said at least one piston being operatively connected to a shaft being able to rotate about an axis of rotation likewise passing through said centre of said housing, in such a manner that said at least one piston executes reciprocating pivoting movements when said shaft is rotating,
at least a first surface extending radially with respect to said housing inner wall and delimiting, on a front side of said at least one piston, at least a first working chamber,
a rotor element rotationally fixedly connected to said shaft and arranged outside said centre of said housing, being arranged on a rear side of said at least one piston, and
said rear side of said at least one piston defining at least one circular running surface which is not radially oriented with respect to said spherical housing inner wall, along which said rotor element runs when said shaft is rotating and which forms an angle of ≠90° with said axis of rotation, while said at least one piston does not rotate about said axis of rotation.

18. The oscillating-piston machine arrangement of claim 17, wherein said first oscillating-piston machine and said at least second oscillating-piston machine have a phase location of working positions of said first piston which are offset relative to one another by a predetermined angle.

19. The oscillating-piston machine arrangement of claim 18, wherein said predetermined angle is 180°.

20. The oscillating-piston machine arrangement of claim 17 wherein said first and second oscillating-piston machines are connected to one another by way of a gear transmission arrangement.
